(19) United States
(12) Patent Application Publication
(10) Pub. No.: US 2006/0049254 A1
(43) Pub. Date: Mar. 9, 2006

(54) Chip card reader with a transparent housing

(75) Inventors: Herve Cunin, Aix En Provence (FR); Carlos Romero-Liceras, Cagnes Sur Mer (FR); Jean-Marc Viande, La Cadiere D'Azur (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: GEMPLUS, Gemenos (FR)

(21) Appl. No.: 10/529,212

(22) PCT Filed: Sep. 17, 2003
(86) PCT No.: PCT/FR03/02737

§ 371 Date: Mar. 25, 2005

(30) Foreign Application Priority Data
Sep. 27, 2002 (FR) 02/12028

(51) Int. Cl. G06K 7/06

(52) U.S. Cl. 235/441

(57) ABSTRACT

A reader for a chip card, whose main surface comprises a set of contact pads and visual indications, includes a housing that defines a slot for introducing the card into a functional position in relation to the housing. The reader also has at least one connector for connecting the card and at least one other electronic component. The electric connector and the electronic component are part of a block of components which is located substantially above the set of contacts. The parts of the housing which extend above the main surface of the card are made of a transparent material.

The present invention relates to a housing for the connection between a terminal device and a chip card.

More particularly, the invention relates to a reader for the connection of an electronic smartcard, also called a chip card, of rectangular shape, of the bank card or “SIM” card type (Subscriber Identification Module), one face of which, called the main face, includes a set of electrical contact pads whose dimensions and position on the main face are standardised for each type or model of card.

The contact set thus generally comes in the form of a rectangle, possibly a square, which includes two series of conducting pads aligned transversally, each series including, for example, three or four parallel conducting pads. The set is placed close to the front transverse edge of the card and is generally centred in relation to the width of the card.

The remainder of the surface of the main face of the card, like its bottom face opposite the main face, is free of any functional feature, which means that it can include visual information on all or part of the area that is not occupied by the set of contacts.

This visual information can, in particular, be used to “customise” the card according to its vocation or use, by identifying its issuing authority and/or its recipient, and/or have an advertising or decorative character.

This can consist of drawings, graphics, photographs, alphanumeric characters, any combination of these elements, etc.

When the card is not being used, the whole of the surface of the main face is accessible visually.

This is not the case when the card is introduced into the housing of a reader, for electrical connection with a view to its use. To this end, the housing is of the type that includes two opposing longitudinal slides defining a horizontal slot for introduction and longitudinal guidance of the card in the housing, and a transverse extremity constituting an end-stop with which the front transverse edge of the card comes into contact in order to establish a functional geometrical position for the card in relation to the housing.

In the familiar manner, for connection by contact with the contact pads, the housing of the reader includes an electrical connector, from which contact elements, in the form of contact strips, extend downwards towards the top face of the card.

The arrangement and the position of the connector in the housing are such that, in functional position for use of the card, also called the contact position, the contact strips of the connector are in contact, individually, with a contact pad.

In accordance with a known design, the reader can also include one or more other electrical and/or electronic components such as, in particular, an integrated circuit for the secure handling of data exchanges between the card and a terminal device, such as a computer, to which the reader is connected, for example, by means of a connecting cable or by any other type of connection using neither wire nor cable. The whole thus constitutes a device called a chip card reader with microcontroller.

Its operation, said to be of the “secured” type, is performed by a security component executing special programmes associated with the security of a particular application.

A reader must be secured, in particular, so that no fraud can occur during execution of the application, and especially so when the application relates to financial transactions.

The electronic circuit or microcontroller is equipped with a programmed read-only memory, for the execution of an application program which is permanently stored in this memory.

The reader can also include at least one other electronic component, called a security component, separate from the microcontroller, which is capable of executing special programs relating to security or to confidential elements of the application under the control of the microcontroller, in such a way that all communication of data between the chip card and the security component must transit via the microcontroller.

Thus, apart from the electrical component which constitutes the connector for the connection with the chip or module of the card, the housing must also be able to accommodate one or more electronic components for execution of the application.

The housing of such a reader therefore comes in the form of a closed element consisting of a blind enclosure with a single opening into which the card is introduced longitudinally from the back to the front.

The card can be introduced fully into the housing, which then takes the form of a pocket which fully envelopes or surrounds the card, or indeed it can be introduced only partly into the housing, in which case only a longitudinal front section of the card is then enclosed. Typically, the length of this section represents between one third and one half of the total length of the card.

The housing is generally created by moulding in an opaque plastic material.

The result of this is that a large part of the main and bottom faces of the card is masked from the view of the users.

Thus, all the efforts of the producers and of the issuing authorities of cards to include visual information on the card are thwarted, since part or all of the card is no longer visible.

In order to remedy this drawback, it has already been proposed that visual information identical to that appearing on the card should be placed on the top and bottom outside faces of the housing of the reader, positioned so as to “complement” those appearing on the part of the card which remains outside of the housing and which is still visible from the outside.

However, such a solution requires that the housing, and therefore the reader, should be designed for a particular card.

In order to remedy these drawbacks, the invention proposes a chip card reader for a card of rectangular shape in which one face, called the main face, includes:
a set of electrical contact pads whose dimensions and position in the main face of the card are standardised, and
on all or part of its surface which is not occupied by the contact set, visual information, in particular for customising of the card according to its use, identifying its issuing authority or for advertising purposes;

of the type that includes a housing whose body delimits a horizontal slot for introduction of the card into a functional position in relation to the housing, and of the type which includes at least one electrical connector for connection with the pads of the card when the latter is in its functional contact position, and at least one electronic component performing an interface function in particular, of the electronic and/or protocol type for communicating between the card and a terminal device to which the reader is connected,

characterised in that the electrical connector and the said electronic component form part of a block of electrical and/or electronic components which, when the card is in its functional position, is located substantially above the contact set, and in that the parts of the body of the housing which extend above the main face of the card, outside of the location area of the component set, are made of a transparent material.

According to other characteristics of the invention:
the body of the housing includes two opposing longitudinal slides, defining the horizontal slot for introduction and longitudinal guidance of the card in the housing, and a transverse extremity constituting an end-stop with which a front transverse edge of the card comes into contact in order to establish the functional position of the card in relation to the housing;
the location area of the component set is connected to the slides by two opposing upper arms which extend generally in a transverse direction;
the average width of each connecting arm is substantially equal to the length of the associated slide;
the length of the slide is less than the length of the card;
the length of the slide is substantially equal to a third of the length of the card;
the slides are displaced longitudinally to the rear in relation to the front transverse edge of the card when the latter is in its functional position;
the component set is placed at the longitudinal front extremity of the housing, and the two upper connecting arms extend, substantially in a V shape, to the rear from the location area of the component set;
the location area of the component set is a recess formed in a central part of the upper wall of the housing which is made of transparent material;
the upper wall of the housing is created by moulding in a transparent plastic material;
the reader includes a lower wall which extends transversally between the slides and which is made of transparent material;
the lower wall of the housing is created by moulding in a transparent plastic material;
the maximum transverse width of the component set is substantially equal to the transverse width of the contact set;
the transverse width of the electrical connector is substantially equal to the transverse width of the contact set;
the component set includes a support board in an insulating material, of substantially rectangular outline, which is located above the contact set and substantially at right angles with the latter, and which carries the components of the component set;
the support board is a printed circuit board;
the electrical connector is mounted under the bottom face of the printed circuit board, and the other components are arranged on the top face of the printed circuit board;
the support board belongs to the electrical connector, and the other components are arranged on the top face of the support board;
the top face of the support board carries at least one luminous indicator which is visible from the outside through the housing;
the transverse width of the support board is substantially equal to the transverse width of the contact set;
the transverse rear edge of the printed circuit board is located substantially at right angles with the transverse rear edge of the contact set;
the support board extends longitudinally to the front beyond the front transverse edge of the contact set;
the front transverse extremity of the support board includes resources for connection of the component set, using a connecting cable of the housing, to a terminal device to which the reader is connected.

Other characteristics and advantages of the invention will become apparent when reading the detailed description that follows. In order to understand this, please refer to the appended drawings in which:

FIG. 1 is a schematic top view of the main face of a standardised chip card;

FIG. 2 is similar to that of FIG. 1, in which is represented, in schematic manner, a component set carried on a printed circuit board, with its connecting cable to a computer;

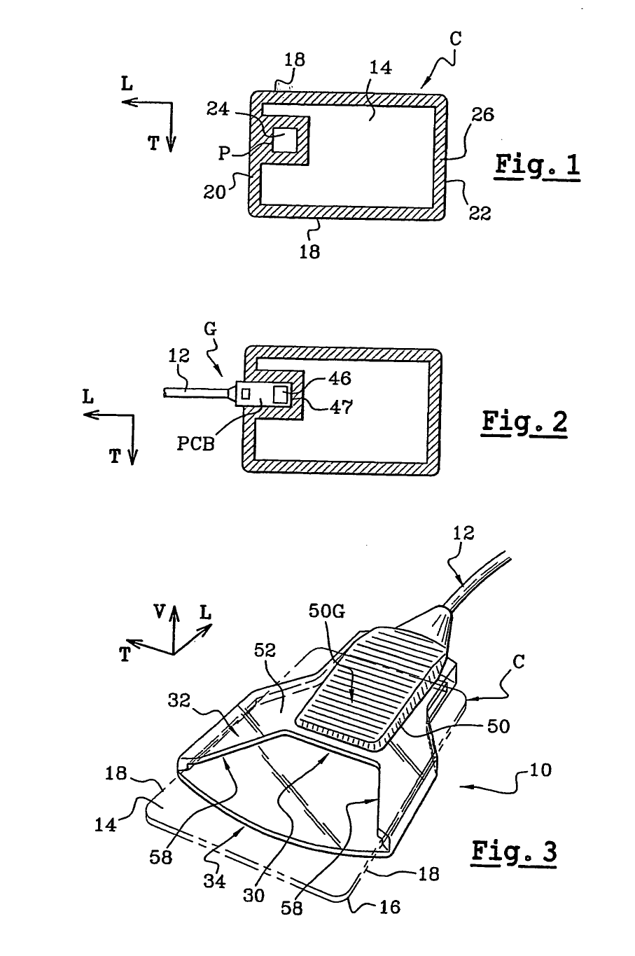

FIG. 3 is a perspective three-quarter rear top view of one exemplary implementation of a reader with a transparent housing in accordance with the teachings of the invention;

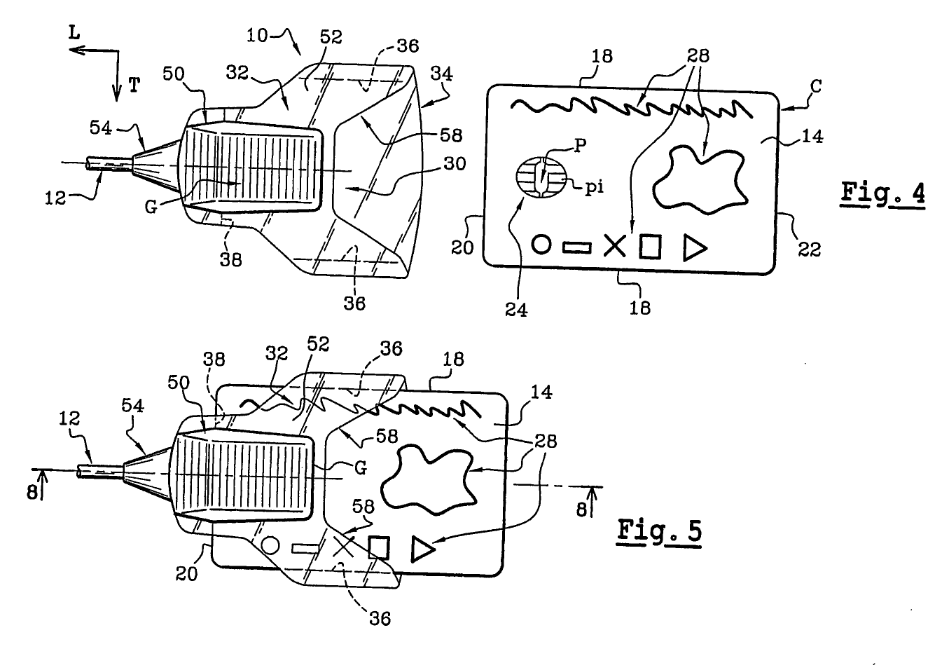

FIG. 4 is a schematic top view of the reader of FIG. 3, showing a card before its introduction into the housing;

FIG. 5 is a view similar to that of FIG. 4, in which the card is shown in its functional contact position after its introduction into the housing of the reader;

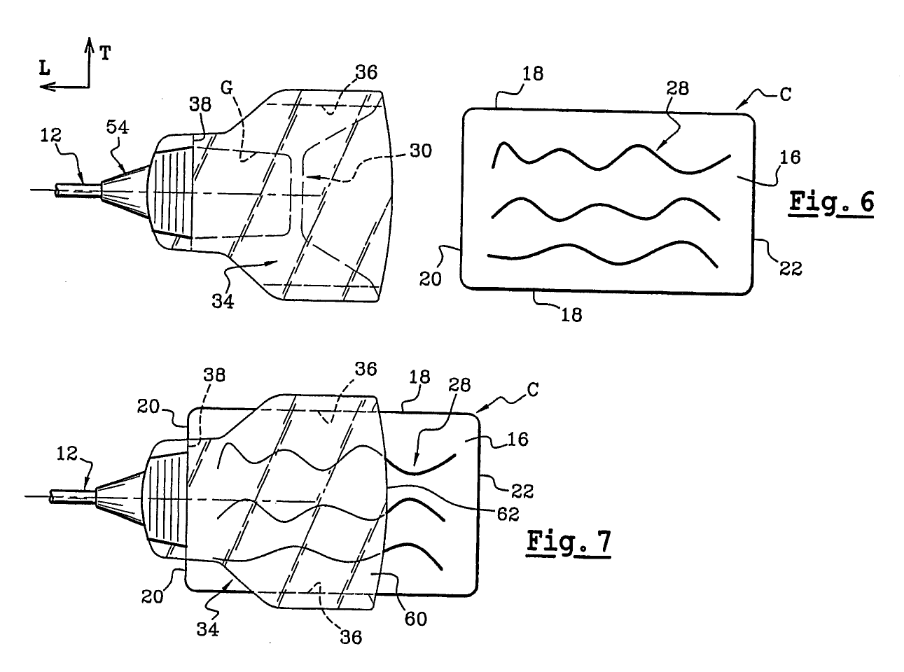

FIGS. 6 and 7 are views from above, similar to those of FIGS. 4 and 5;

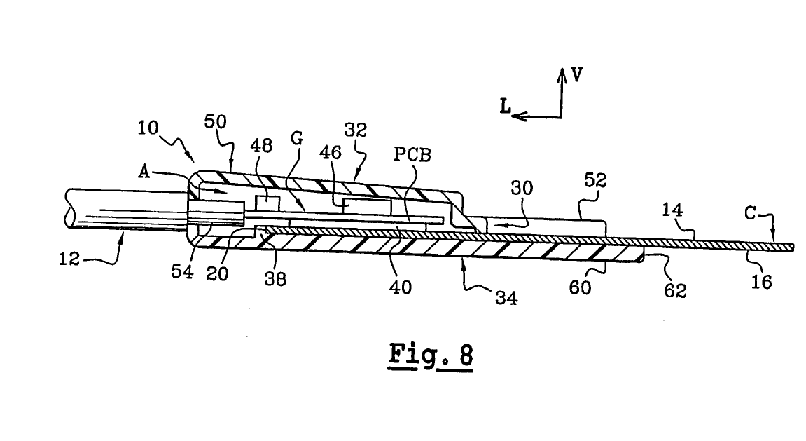

FIG. 8 is a schematic view in section on the median vertical and longitudinal plane 8-8 of FIG. 5.

In the description that follows, and also in the claims, the terms longitudinal, transverse, and vertical will be used in a non-limited manner with reference to the LTV coordinates shown in the figures, as well as the terms front and rear on the longitudinal axis, and as they will be defined in the description.

Identical or similar components will be designated by the same reference numbers.

The figures show a reader for the connection of a card (C) to an electronic appliance or terminal device, not shown, such as a computer, to which the housing (10) of the reader is connected by means of a connecting cable (12).

Here, the card (C) is a standardised chip card currently used, in particular, to constitute a payment card in a banking network, which is of a general rectangular shape with its four corners rounded. The card (C) includes a main horizontal top face (14) and a parallel bottom face (16).

The card is defined laterally by two parallel longitudinal edges (18) and by two transverse edges, front (20) and rear (22), which correspond to the transverse width of the card (C).

In the standardised manner, the main top face (14) is that which includes the electronic module or chip (24) whose geometrical position in the face (14) is perfectly established and standardised.

In this type of card, the chip (24) is located close to the front transverse edge (20) and is substantially centred transversally, though being slightly displaced towards one of the longitudinal edges.

Shown in the form of a hatched area (26) are the portions, here of the top face, which are specified as being used for the guidance of the card and other mechanical functions, and also to create the zone surrounding the module.

In the familiar manner, as can be seen in particular in FIG. 4, for electrical connection with the integrated circuit module(s) (24), the top face (14) includes a set (P) of electrical contact pads (pi) which is located vertically above the module, and therefore generally in the standardised geometrical zone (24) shown in FIGS. 1 and 2.

The remainder of the surface of the main top face (14) is free, and it generally includes visual information (28) of various types, such as inscriptions, drawings, photographs, alphanumeric characters, etc.

In accordance with the wishes of the producer or the issuing authority of the card, this visual information (28) can cover the whole of the top surface (14), with the exception, naturally, of the zone occupied by the module, or more precisely by the set (P) of contact pads (pi).

As can be seen in FIGS. 6 and 7, the bottom face (16) of the card (C) can also include visual information on all of its surface, which is fully available here for such inscriptions to the extent that it includes neither module nor contact pads.

On the bottom face (16), the information (28) can, in particular, consist of text which includes a method for using the card (C) and/or the application incorporated into the reader.

In a known manner, the housing (10) comes in the form of a body of generally flattened shape, at least partly complementary to the rectangular shape of the card (C), and which includes, in particular, a horizontal slot (30) allowing the longitudinal introduction of the card (C) from back to front, that is from right to left as illustrated in FIGS. 4 to 7, with the slot (30) opening out to the rear for this purpose.

As in the embodiment represented in the figures, the body of the housing (10) is made of two parts, top (32) and bottom (34) which, after assembly, are connected together by any suitable means on a horizontal joint plane corresponding substantially to the plane of the horizontal slot (30), and therefore to the plane of the card (C).

The housing (10) includes resources for the guidance and positioning of the card (C) into a functional contact position in the housing (10), resources for electrical connection with the pads (pi) of the card (C), electronic components specific to an application, and a cable (12) for connection of the reader to the outside.

In a known manner, for the guidance and the positioning of the card, and also in order to define the introduction slot (30), the housing (10) includes two opposing longitudinal slides (36) whose the transverse separation corresponds to the distance separating the two parallel longitudinal edges (18) of the card (C) which are held by sliding between the slides (36), the height of which corresponds substantially to the thickness of the card.

To position the card (C) longitudinally in the housing (10), and therefore in the reader, the slot (30) is defined longitudinally at the front by a transverse extremity (38) which, as can be seen in FIG. 8, is made of the wall or bottom part (34) of the housing (10), for example.

The transverse extremity (38) constitutes an end-stop against which the front transverse edge (20) of the card (C) comes into contact in order to establish the end of travel of the longitudinal introduction of the card (C) into the housing (10), and therefore in order to determine, in combination with the slides (36), the position of the set (P) of pads (pi) in relation to the housing (10).

In a known manner, in order to ensure for the electrical connection with the pads (pi), the housing (10) includes an electrical connector (40), of a generally known design (not shown in detail) which includes, in particular, elastically deformable contact strips which come into contact with the patented pads which extend from a support board in an insulating plastic material. The contact strips, not shown, of the connector extend vertically downwards towards the top face of the card (C) when the latter is in position in the housing (10).

In the embodiment represented in figures, the electrical connector (40) is fixed under the bottom face (42) of a printed circuit board (PCB) which is accommodated in the upper part or wall (32) of the housing (10) and which, in this embodiment, constitutes the support board for all the components of the component group or set.

On its top face (44), the board (PCB) carries at least one electronic circuit (46) such as a microcontroller and, for example, a LED diode (48) which constitutes a warning light showing the operation of the electronic circuits of the reader.

Finally, at its longitudinal front extremity, that is on the left looking at FIG. 8, the board (PCB) includes resources for the connection of its circuits to the connecting cable (12) which extends longitudinally at the front to the outside of the reader (10).

As can be seen particularly in FIG. 2, the board (PCB) is of generally rectangular shape, and its dimensions and positioning are such that it extends vertically substantially above and at right angles with the module (24) and therefore of the contact pads (pi) of the set (P) without in any way covering or overlapping the other parts of the top face (14) surrounding the set (P) (or module (24).

The board (PCB), with the connector (40) and the other components (46, 48) that it is carrying, thus constitutes the component group or set (G) of the housing (10) which is accommodated in the top part (32), above the module (24) with its contact set (P) pads (pi).

To this end, the top part (32) includes a front central part (50) forming a bulge, or projecting part, above the generally horizontal top face (52) of the top part (32).

As can be seen, in particular in FIGS. 4 and 5, the central bulge (50) extends longitudinally to the front beyond the transverse extremity (38), and therefore beyond the front transverse edge of the card (20) when the latter is in place in the housing (10), in particular to allow the positioning of the connecting cable (12) with its resources (54) for connection with the board (PCB). These connection resources (54) are embodied either so as to belong permanently to the housing (10) or in the form of connectors (not shown in detail) which can be connected to or disconnected from the housing, such as a standard USB connector for example.

In accordance with the teachings of the invention, at least the top part (32) of the housing (10) is created by moulding in a transparent or translucent plastic material, and only the central part or bulge (50) which accommodates the component group or set (G) is not transparent, which means that only this zone does not allow one to see the surface of the main face (14) of the card. To the extent that the component group or set (G) extends generally only above the contact set (P), virtually all of the visual information (28) can be seen, in particular by being visible through the top part (32) in transparent material.

In order to further improve the visibility of the information (28), the central part (50) of the location of the component group or set (G) is connected to the slides (36) by two opposing upper arms (58) which extend transversally from the central part (50), and here arranged to slope from the front to the rear so as to constitute substantially the shape of a V, seen from above.

The width of each arm (58) is substantially equal to the length of the associated slide (36), and the length of the slide (36) is clearly less than the length of the longitudinal edge (18) of the card (C), and here it is equal to substantially a third of this length.

In order to ensure correct guidance and correct retention in position of the card (C) in the housing (10), the slides (36) are displaced longitudinally to the rear in relation to the transverse extremity (38), and therefore in relation to the front transverse edge of the card (20) when the latter is in position, so as to perform the longitudinal guidance of the edges (18) along a central section of these edges (18).

Thus, only the short and transparent arms (58) extend above the top face (14), of which the main part of the surface is visible directly from the outside.

As can be seen, in particular, in FIGS. 6 and 7, the bottom part (34) of the housing is generally complementary to the top part (32). Here it is also created preferably by moulding in a transparent plastic material and generally comes in the form of a plate or partition (60) with a horizontal bottom.

In order to perform correct retention and correct positioning of the card (C), the bottom part (34) is not cut away at the rear (to align with the V-shaped arms), but it is defined by a transverse rear edge (62).

Thus, the bottom wall (34) constitutes a transparent bottom which extends substantially over more than half the area of the bottom face (16) of the card (C).

However, as can be seen in FIG. 7, all of the information (28) is visible directly from the outside, or indirectly by transparency through the bottom part (34).

The transverse width of the electrical connector (40) is conventionally substantially equal to the transverse width of the contact set (P).

Advantageously the maximum transverse width of the component group or set (G) corresponding to the transverse width of the board (PCB) is substantially equal to the transverse width of the connector (40) arranged under the bottom face (42) of the board (PCB), this total width of the group or set (G) thus being preferably less than or equal to the transverse width of the contact set (P).

As can be seen in FIG. 2, the transverse rear edge (47) of the board (PCB) is located substantially at right angles with the transverse rear edge of the module (24), that is of the contact set (P) while the board (PCB) is extended longitudinally beyond the front transverse edge of the set (P).

The fact that the top part (32) is moulded in a transparent plastic material allows one to see from the outside whether the LED diode (48) is on or off.

According to another embodiment which is not shown, the printed circuit board can be deleted, and the support board for the components of the component group or set is then composed of the rectangular board, in insulating plastic material, of the connector which carries the contact strips and whose the top face then carries the other components making up the component set or group.

1. A chip card reader for a card of rectangular shape having a main face that includes:
a set of electrical contact pads, of which the dimensions and the position on the main face of the card are standardised; and
over all of its surface, or any part that is not occupied by the contact set, visual information for customising of the card according to its use, identifying its issuing authority or for advertising purposes;
said card reader including a housing, having a body which defines a horizontal slot for the introduction of the card into a functional position in relation to the housing;
and at least one electrical connector for connection with the pads of the card when the latter is in its functional position, and at least one electronic component performing an interface function between the card and a terminal device to which the reader is connected,
wherein the electrical connector and said electronic component form part of a set of electrical components and/or electronic components which, when the card is in its functional position, is located substantially above of the contact set,
and wherein parts of the body of the housing which extend above the main face of the card, outside of the location area of the component set, are made of a transparent material.

2. A reader according to claim 1, wherein the body of the housing includes two opposing longitudinal slides which delimit the horizontal slot for introduction and longitudinal guidance of the card in the housing, and a transverse extremity constituting an end-stop with which a front transverse edge of the card comes into contact in order to establish the functional position of the card in relation to the housing.

3. A reader according to claim 2, wherein the location area of the component set is connected to the slides by means of two opposing upper arms which extend generally in a transverse direction.

4. A reader according to claim 3, wherein the average width of each connecting arm is substantially equal to the length of the associated slide.

5. A reader according to claim 3, wherein the length of the slide is less than the length of the card.

6. A reader according to claim 5, wherein the length of the slide is substantially equal to a third of the length of the card.

7. A reader according to claim 5, wherein the slides are displaced longitudinally to the rear in relation to the front transverse edge of the card when the latter is in its functional position.

8. A reader according to claim 3, wherein the component set is placed at the longitudinal front extremity of the housing, and wherein the two upper connecting arms extend, substantially in a V shape, to the rear from the location area of the component set.

9. A reader according to claim 1, wherein the location area of the component set is a recess formed in a central part of the upper wall of the housing, which is made of transparent material.

10. A reader according to claim 1, wherein the upper wall of the housing is created by moulding in a transparent plastic material.

11. A reader according to claim 1, further including a lower wall which extends transversally between the slides and which is made of transparent material.

12. A reader according to claim 11, wherein the lower wall of the housing is created by moulding in a transparent plastic material.

13. A reader according to claim 1, wherein the maximum transverse width of the component set is substantially equal to the transverse width of the contact set.

14. A reader according to claim 1, wherein the transverse width of the electrical connector is substantially equal to the transverse width of the contact set.

15. A reader according to claim 1, wherein the component set includes a support board in an insulating material of substantially rectangular outline, which is located above the contact set, substantially at right angles with the latter, and which carries the components of the component set.

16. A reader according claim 15, wherein the support board is a printed circuit board.

17. A reader according to claim 16, wherein the electrical connector is mounted below the bottom face of the printed circuit board, and wherein the other components are arranged on the top face of the printed circuit board.

18. A reader according to claim 15, wherein the support board belongs to the electrical connector, and wherein the other components are arranged on the top face of the support board.

19. A reader according to claim 24, wherein the top face of the support board carries at least one warning light which is visible from the outside through the housing.

20. A reader according to claim 25, wherein the transverse width of the support board is substantially equal to the transverse width of the contact set.

21. A reader according to claim 15, wherein the transverse rear edge of the printed circuit board is located substantially at right angles with the transverse rear edge of the contact set.

22. A reader according to claim 15, wherein the support board extends longitudinally to the front beyond the front transverse edge of the contact set.

23. A reader according to claim 15, wherein the front transverse extremity of the support board includes resources for the connection of the component set with a cable for connection of the housing to a terminal device to which the reader is connected.

24. A reader according to claim 8, wherein the component set includes a support board in an insulating material of substantially rectangular outline, which is located above the contact set, substantially at right angles with the latter, and which carries the components of the component set.

25. A reader according to claim 13, wherein the component set includes a support board in an insulating material of substantially rectangular outline, which is located above the contact set, substantially at right angles with the latter, and which carries the components of the component set.
